(19) United States
(12) Patent Application Publication
(10) Pub. No.: US 2019/0163803 A1
(43) Pub. Date: May 30, 2019

(54) Methods and Systems for Classifying Design Compositions Using Aggregate Data Derived from a Composition Collection

(71) Applicants: Sarah-Eva Ellen Marchese, Rockford, IL (US); Nathan Marchese, Rockford, IL (US)

(72) Inventors: Sarah-Eva Ellen Marchese, Rockford, IL (US); Nathan Marchese, Rockford, IL (US)

(21) Appl. No.: 15/823,197

(22) Filed: Nov. 27, 2017

(51) Int. Cl. G06F 17/30

(52) U.S. Cl. CPC G06F 17/30598; G06F 17/30345; G06F 17/30283

(57) ABSTRACT

The invention is directed to methods and apparatus for associating creative compositions, composition properties, a composition's composite elements, the properties of the elements, and classifying terminology associated with the composition with data aggregated from a collection of individual compositions. The aggregate data is associated with individual compositions, elements, classifications, and their properties to provide objective or quantifiable statistical data associated with those objects for precise description, categorization, and classification.

### COPYRIGHT NOTICE

A portion of this patent document's disclosure contains material that is subject to copyright protection. The copyright owner does not object to the facsimile reproduction by anyone of the patent document or the patent disclosure as it appears in the Patent and Trademark Office patent file or records, but otherwise reserves all copyright rights.

### CROSS-REFERENCE TO RELATED APPLICATIONS

This application claims the benefit of U.S. Provisional Application No. 62/403,141; filed Oct. 1, 2016. Pursuant to 37 CFR 1.78(B)(1)(iii), the petitioners' failure to file this nonprovisional application seeking the benefit of the above referenced provisional application within the twelve-month period set forth in paragraph 37 CFR 1.78(a)(1)(i) was unintentional.

### BACKGROUND OF THE INVENTION

### 1. Field of the Invention

The invention is directed toward the field of commercial creative composition. More specifically, the invention is directed toward the consumption of creative compositions in all their forms, and toward providing patrons or consumers of such compositions an accurate, easy, economical, and fast means to articulate design specifications, thus ensuring that commissioned works meet their design expectations and tastes.

### 2. Background of the Invention

a. The Demand for Personalized Creative Compositions

There is a strong demand, particularly among the millennial generation, for personalized creative compositions in a variety of aspects of their lives, from events to home décor to personal attire. Some studies have shown that one in five consumers is willing to pay a 20% premium for customized over noncustomized goods.

Unfortunately, patrons and consumers of customized compositions are often met with a number of limitations in the current technology, including limited customization options, lack of guidance for identifying their own style preferences, imprecise or vague classification terminology which causes miscommunications when articulating design specifications, and limited ability to provide specific, objective design criteria, and thus being forced to adopt vague design terminology and ultimately receiving compositions that are unsatisfactory from the perspective of the consumer's or patron's tastes and expectations.

While the demand for customized goods has always been present for professional endeavors (e.g., business cards and logos, etc.) and certain traditional occasions (e.g., wedding floral arrangements and wedding dresses, etc.); current technology has made available a much broader range of customization options and given current generations the sense that they can customize the style around them in a broader range of means than ever before. Studies suggest that an estimated $800 billion dollars in revenue will be shifted to the 15% of companies that get personalization right in retail, health care, and financial services with 6-10% revenue growth expected for brands that deliver personalized experiences via digital technology (a growth rate 2 to 3 times faster than that of companies that don't).¹ Today's customization solutions embrace a range of composition options from custom textiles, home décor, floral arrangements, paper goods, and a wide array of other creative compositions reflecting the individual's design tastes and personal style. Examples of such customization solutions include: Custom Made (custom jewelry, home décor goods, and attire: http://www.custommade.com/gallery/customn-jewelry/); Tulle & Chantilly (custom wedding attire: http://www.tulleandchantilly.com/design_your_own_wedding_gown.html?pblog); Shoes of Prey/Upper Street (custom footwear: https://www.shoesofprey.com/); CustomInk (custom t shirts: http://www.customink.com/); MegaPrint, Inc. (custom wallpaper and murals: http://www.megaprint.com/wallpaper.hph); Spoonflower (custom wallpaper: http://www.spoonflower.com/designs/new?create=wallpaper); Vistaprint (custom paper goods and business products: http://www.vistaprint.com/custom-tshirts.aspx?couponAutoload=1&GP=8%2f5%2f2016+1%3a31%3a59+PM&GPS=4032633017&GNF=0); Night Owl Paper Goods (paper goods and wood crafts: http://nightowlpapergoods.com/); and countless other customization solutions. ¹https://www.bcg.com/publications/2017/retail-marketing-sales-profiting-personalization.aspx

For many of these customization and design services, the common hallmark is convenience, ease, and price. However, these solutions fall short in a number of ways with providing a patron tools with which to articulate design preferences, identify features and components that satisfy their preferences or create their desired style, and how to identify the field of existing compositions and the creative space available to uniquely distinguish their composition design, without venturing outside their design style and preferences.

b. Problems in Representative Field: Floral and Wedding Bouquet Customization and Design Industry

One field of creative composition which exemplifies both the ubiquity and nature of the problems surrounding creative composition and the inadequacy of existing solutions to the problem is the field of floral design, particularly with respect to customized wedding arrangements.

A 2009 study by the Society of American Florists indicates that younger generations, specifically the millennial generation, see flowers as a means of articulating their personal style both at home and in their weddings. They see flowers as a way to enhance the style associated with their broader tastes or styles as expressed in their personal attire, home décor, and general views on life. Further, there is a strong demand that this personalized expression feel unique as opposed to a “cookie cutter” arrangement or one using common design aspects or features lacking individual features to distinguish it from previous designs, while maintaining a look and feel representative of the individual's personal style.

At the same time, however, millennials know even less about flowers than preceding generations. Millenials not only know less about flowers, but less about floral style trends and, therefore, are less able to articulate their tastes, styles, and expectations for their bouquet preferences and design specifications, creating a major impasse to commissioning satisfying floral compositions.

For the first time in 2010, florists made it to Angie's List's top ten industries engendering the most complaints from customers. Follow-up surveys indicated that 85% of respondents had used florists for pre-made or customized arrangements. But 43% of those reported having more negative than positive experiences with florists.

A major cause of dissatisfaction among millennial flower consumers, and the flower consuming public generally, is the sense that customized floral arrangements fail to meet their expectations or to appropriately match their personal style. One of the main causes of the disjunction between floral compositions and consumer expectations is the ubiquity of vague design classification terminology. Bouquets are frequently referred to by general and often imprecise design classifications, such as bohemian, rustic, garden, exotic, old world, etc. Alternatively or conjunctively, they are referenced by vague style characteristics such as traditional vs. modern, natural vs. styled, formal vs. casual, etc. Or they may be referenced in relation to a specific time period or cultural association, such as 1920s, 1930s, or East Asian or Victorian styles, etc.

Use of such terminology is subject to several limitations. First, these terms lack any precise universally accepted definition. This is due to the fact that, as many would observe, there is no single set of characteristics that encompass all arrangements classified under a single design look or classification; rather design classification trends tend to arise out of clusters of characteristics and design elements generally common to a particular style, but not individually necessary to give rise to the style. Indeed, different individuals, different designers, different florists, and different patrons or consumers will have varying and inconsistent understandings of these terms, resulting in miscommunications about the nature of particular design criteria. This phenomenon closely matches the problem of “family resemblances” described by Ludwig Wittgenstein:
Instead of producing something common to all that we call language, I am saying that these phenomena have no one thing in common which makes us use the same word for all,—but that they are related to one another in many different ways . . . .
Consider for example the proceedings that we call “games” . . . . [i]f you look at them you will not see something that is common to all, but similarities, relationships, and a whole series of them at that . . . .
And the result of this examination is: we see a complicated network of similarities overlapping and criss-crossing: sometimes overall similarities, sometimes similarities of detail.
I can think of no better expression to characterize their similarities than “family resemblances”; for the various resemblances between members of a family: build, features, colour of eyes, gait, temperament, etc. etc. overlap and criss-cross in the same way.² ² Wittgenstein, L. & Anscombe, G. E. M. (1997), §§ 65-67. Philosophical Investigations. Oxford, UK: Blackwell.
   This aptly describes the conundrum of consumers in the field of creative composition, where design terminology is frequently directed at an overall “look and feel” for a composition, which may arise from many different permutations of characteristics or design components or elements, but which may be wholly distinct from one composition to the next.

As an example applying this conundrum to floral arrangement terminology, the term “rustic” may apply to a wide array of arrangements, which may individually not share any characteristics or common elements whatsoever, yet may still be properly classified as “rustic” based on general similarities to wide arrays of rustic arrangements. An example of two such decorative plant compositions might include one with a cascade shape, a focal point, pink flowers, and made entirely of foliage and filler shaped flowers, and a second with a teardrop shape, no focal point, and made entirely of round and small line shaped flowers and without any foliage.

This lack of definitive characteristics has resulted in several problems which result in disappointment in arrangement consumers. First, many consumers do not even know “their look,” or what style classification they identify with, despite having a strong desire for flowers that express their personal style. The lack of any precise style terminology presents a barrier to them even identifying the look and feel that expresses or represents their personal style.

Second, many consumers may have a feel for the characteristics that correspond to the look and feel they are targeting, but cannot identify the design classification that corresponds to their target style. Given the lack of precise terminology they often use a terminology that fails to correctly correspond to the style they have in mind.

Third, even for consumers who know some characteristics that they desire, and can identify a classifying term that meets those characteristics, the lack of any precise and universally accepted definition of a characteristic means that they may get a decorative plant composition that falls within the target style they request, but has none of the particular characteristics that the consumer actually identifies with their style in the first place.

Fourth, given the lack of universally accepted definition for a given classification, even when a consumer accurately identifies and requests a bouquet by a term that is accurately compatible with their personal style, there is no guarantee that the design artisan charged with completing the design composition will share the same understanding of the style classification that the consumer has, and, thus, the florist may create a composition that fails to meet an even otherwise accurate commission order.

Fifth, even where a consumer accurately identifies a style classification corresponding to their personal style and communicates that classification to a composition artisan in such a way that they share the general understanding of the target look, consumers still encounter a challenge in making their creation unique or distinct from existing compositions. In addition to fitting their personal style, there is strong demand for bouquets to express that style in a way that does not feel “cookie cutter” or simply a repetition of compositions that have already been created. Current solutions provide a user no means to employ novel elements or design characteristics in a composition while being confident that they will not alter the target look and feel of their composition expressing their personal style.

Sixth, setting aside all the challenges above presenting barriers to consumers getting a composition that is satisfactory and matches their design expectations, existing solutions for consumers without a strong background in creative composition design all require expenditure of extensive resources both to identify their personal style, identify the proper means of classifying that style, and identifying ways to uniquely express that style in their composition.

c. Existing Solutions in Representative Field: Manual Research of Image Resources

Consumers' most common point of entry to floral design is rote manual research by finding and looking at photographic images of bouquets. The most frequent resources to assist in locating bouquet images are online image search resources and traditional bridal or floral print publications and online blogs.

Online image search resources include search engines such as Google and Pinterest. Both these resources enable users to query terms and return images in response. These solutions are subject to a number of limitations, not least of which is that they provide no preliminary guidance in identifying the proper search terms which will return images in the user's desired style. Once images are returned, there is little or no guidance for classifying them by identifying the design look or style of the composition, the elements the composition is created from, the design characteristics of the composition itself or its elements, or guidance in identifying and locating similar compositions. Even when design composition elements are identified, it is up to the user to discern which compositions meet their style and taste, and what specific characteristics of the compositions give rise to the look and feel they identify with. Nor do these resources provide any guidance with the range of customization options by which users may alter a design or which common characteristics are available within a particular style that can be customized without taking the arrangement out of their target style or design look.

Bridal or floral print resources and blogs often provide some floral or style information about an individual composition, but also fail to provide comprehensive style guidance with which a user may make a design their own. They offer no information regarding the trendiness of a particular style or characteristic. They offer no information about alternative design options.

Furthermore, research using mere photographic images is itself insufficient in a number of ways. Presenting one or several images to a florist as a means of articulating style is notoriously imprecise and often leads to miscommunications and dissatisfaction with the final composition. It is also a remarkably poor way for a consumer to obtain a unique or distinct design, as, by definition, the specification itself relies on something that has already been done.

Furthermore, researching by simply powering through a volume of images is an inefficient means of identifying and articulating one's design style. It can take dozens, or hundreds, of hours to locate a sufficient volume of images and identify a user's preference. Even if a user were able to identify appropriate image resources, these tools fail to provide a convenient and economical means of indexing hundreds or thousands of individual flowers or compositions across multiple characteristics to identify and articulate the user's style preferences.

Additionally, photographic resources are poor guides to what is and is not possible in floral design. They fail to provide any guidance as to the plants that are seasonally or commercially available on a given date or in a given location. They fail to specify the plant weights or shapes that may be compatibly designed with compatible structural components, such as wire or bouquet holders, in a particular bouquet structure.

d. Existing Solutions in Representative Field: Wire Service Networks and the Organization of the Commercial Floral Marketplace

Existing solutions to the issue of floral creative composition are inadequate to solve the issues enumerated above. The fundamental core of the problem resides in consumers' limited design and style expertise and knowledge foundation. While this has been true for countless generations, these problems are particularly acute in the millennial generation which simultaneously demands greater personalization than previous generations, but knows far less about flowers than their predecessors.

Initially, the floral design industry is fundamentally built on a system that gives the consumer little to no decision-making power. The traditional and near ubiquitous point of industry contact for consumers of floral compositions is the local floral shop. In addition to processing orders directly, independent flower shops often maintain relationships with wire services which provide networks for these independent florists and facilitate the transfer of orders. Wire services, such as 1-800-Flowers, FTD, and Teleflora operate as a middleman, processing orders and transmitting them to local florists for fulfillment. The designation “wire service” is a nod to the system's technological origin in the era of the telegram.

To maintain consistency of available products on a nationwide basis among the network of thousands or independently owned floral shops, these wire services maintain a standardized catalogue of pre-constructed plant arrangements. Flower purchasers select one or more of these pre-constructed arrangements based on stock images. The independent florist must then construct an arrangement meeting the exact specifications of the standardized arrangement ordered. This prevalent model of floral arrangement, while providing benefits in consistency and supply chain economics, leaves little to no customization space for the consumer.

Furthermore, such solutions fail to provide any guidance to the consumer in obtaining an arrangement in a particular style. Arrangements are typically divided in the preconstructed arrangement catalogues only by event, e.g., funeral flowers, mother's day flowers, birthday flowers, etc. There is little to no indication, or easy means to discern, what the style or design look of a given arrangement. Even if a description identifies a particular design look, e.g. rustic, whimsical, boho, etc., there is no guarantee that the look will match the user's expectations given the lack of universal understanding and frequent inconsistent understandings as to what falls under these categories. And even where a particular arrangement is described in terms of a particular look or style, the consumer still lacks any means of adapting the look they don't know what it means for an arrangement to be in a particular look in the first place.

While a number of alternatives to the traditional wire service network system have recently arisen in the marketplace, none of these alternatives offers substantially greater customization options for the flower consumer. One recent industry alternative is BloomNation (www.bloomnation.com), which operates as the self-described “Etsy” for flowers. Through their online marketplace, consumers can browse and order floral designs posted by local florists. While this system allows individual florists freedom to create their own designs, it does not offer consumers any additional utility to personalize arrangement designs themselves. Nor do these solutions facilitate consumers' ability to understand, articulate, or formulate their own unique designs in their personalized style.

Another alternative is Bouqs (www.bouqs.com), which acts as a direct-from-wholesaler point of contact for consumers. Through the Bouqs marketplace, consumers can browse and order preconstructed arrangements. Upon order, the flowers are cut and directly delivered, cutting out potentially multiple layers of the supply and distribution chain inherent in the traditional model. Again, however, this system does not provide any increased utility for the consumer, either in terms of personalization of floral design or in terms of merely finding something that meets their own design style expectations or desires.

e. Existing Solutions in Representative Field: Floral Arrangement Imaging Technologies

Although traditional sources for decorative plant consumption fail to provide means of consumer customization, there are several services available providing floral personalization and customization utility.

A number of services create visual representations of flower arrangements that a user can alter to create a customized virtual arrangement design. Such technologies have been disclosed in, for example, U.S. Pat. No. 5,440,479 (a floral kiosk ordering system with visual ordering information), U.S. Pat. No. 7,337,413 B1 (a system and method for designing a bouquet from selected images); U.S. Pat. No. 8,954,875 B2 (a method for providing a visual representation of floral arrangements by arranging selected images into templates); United States Patent Application Publications US 2006/0064314 A1 (a graphical user interface which combines images of selecting floral items); US 2009/0063302 A1 (a floral arrangement marketplace featuring a what-you-see-is-what-you-get interface displaying floral arrangements composed of selected images); US 2012/0198387 A1 (a computer-implemented method and tool for creating a virtual floral arrangement); US 2015/0019368 A1 (a floral arrangement customization system allowing a user to create and modify a customized floral arrangement); and World Intellectual Property Organization Patent WO 2012/005385 A1 (a method for customizing online flowers involving creation of a customized bouquet image). Comparable instantiations of these visual arrangement development tools are available online at Russian Flora (http://www.russianflora.com/bouquet-builder.php); the website of Interflora's United Kingdom affiliate (http://www.interflora.co.uk/myinterfloracreation.xml); Designed by the Bride (http://desinebythebride.com/you-design/free-editor/); and centralpark.com (https://www.centralpark.com/virtual-bouquet/create).

While each of the above listed solutions provides a means to visually arrange flower images into various combinations and configurations, none of the above utilities provides any further guidance in identifying a user's overall design look and feel or any assistance in selecting terminology to articulate that look and feel to a floral designer. There is no means of translating what they might have seen elsewhere or an idea in their head into a design that can both be replicated and is unique. Instead, they rely on the user to sufficiently understand design principles to create an arrangement in their look and feel themselves, with no information or guidance, which is inadequate for casual consumers without a strong basis in floral design expertise.

Furthermore, these solutions themselves provide no design instruction, merely permitting users to transpose images of flowers without any discernible guidance or restrictions which would assist a user in achieving a target look and feel or personalized style. They neither help someone make something look good (or in a particular style) not deter them from doing something that will result in them not achieving their goals. Nor do these solutions identify the range of personalization and style options available. Nor do these solutions index actual uses and provide a means of discerning unique design options or principles to guide the consumer in creating a unique design. Instead, these solutions rely on a static database of flower images, which tend to be a selection of those commonly used flowers which have been popularized and made consistently available by their inclusion in the standardized bouquets in the wire service catalogue. As a result, consumer variety in flower selection in these solutions is limited in much the same way that it is limited in selecting bouquets through a local florist or wire service.

Furthermore, while these tools provide utility in terms of creating visual representations of various floral configurations, these tools provide no utility for consumers who desire to select flowers for a customized arrangement based on non-visual criteria, particularly criteria related to a flower's role and uses in traditional and/or contemporary culture. These tools focus on providing consumers see a visual representation of a bouquet, implicitly assuming that they can decide, based on that image, both what to use and how to explain what it is about the representation that they like or want. But such a solution does not help a consumer go beyond a vague approximation of what they want to a precise articulation of their preference in actionable, design terms. Therefore, a solution is needed which facilitates floral arrangement customization based on a full range of characteristics, including nonvisual cultural characteristics or style guidance.

f. State of the Art—Horticultural Decorative Plant Indexing and Searching Services

While existing solutions for decorative plant searching, inventory, and provision tend to narrow the field of searchable or identifiable plants, there are solutions focused on the horticultural arts which provide access to expansive flower collections, beyond those available in the above described solutions. These solutions tend to focus on identification of unknown plant species and genera and the conditions necessary for individuals to cultivate flowers themselves. However, several limitations of such systems limit their utility to individuals interested in personalized design composition.

One example of a horticultural tool for plant identification is provided through Aerulean (http://www.aerulean.com/?selected_category_ids=&image_type=general&name_id=). This tool permits flower searches by plant name or country. It allows users to refine searches by identifying a variety of horticultural characteristics, such as growing condition requirements, flower shape and formation, leaf shape and configuration, and plant form or type. The tool does not facilitate ordering or provide any design guidance or data on floral design compositions. Furthermore, by emphasizing technical horticultural characteristics, such tools are of limited use to consumers lacking a background in horticultural or botanical sciences. The system is not in any way structured to help a consumer figure out what it actually is that they want. This solution is not useful to help consumers figure out what they actually want in a decorative plant arrangement design.

g. Conclusion: Application of Principles Identifies Above Generally to the Multiple Fields of Creative Composition

While the above detailed breakdown of the challenges facing creative composition exemplifies the particular problems and deficient solutions particular to the floral design industry, it may be readily appreciated that these challenges generally face patrons desiring a commissioned and/or otherwise customized composition in any medium or design field.

Creative compositions rely on individualized design taste, which is often articulated in terms of ubiquitous, but vague and subjectively understood design classifications. This imprecision acts as a barrier to consumers who desire a commissioned composition in a particular style, but who lack understanding of classifications and terms of art in the industry to accurately describe the classification of the work they desire to order. Likewise, the lack of strong foundation in design principles may prevent a consumer, patron, and/or other order of custom creative composition from identifying specific or particular design characteristics, components or elements as parameters for a commissioned composition to meet their style requirements while expressing a unique and personal style.

Thus, it would be desirable to have a solution which allows consumers to conveniently and economically identify and articulate their style preferences for creative composition. It would be desirable to have a solution which allows users to supplement or replace vague and subjective design classifications with specific, precise, and objective information about specific design aspects, characteristics, and components or elements. It would be further desirable for the solution to provide a means for users to precisely and accurately identify specific features of a design composition which would permit an artisan, craftsman, or design composer to incorporate such elements in a means satisfactory to the user and in accordance with the user's expectations in terms of style, meaning, or other forms of aesthetic, expressive, or intangible qualities. It would further be desirable for this system to provide sufficient data on the universe of design possibilities and practices to allow a consumer to make adjustments and to request a unique design, without venturing outside their target style preference. It would be useful for the solution to provide specific, objective design data without the need to research dozens of individual compositions and draw one's own conclusions about the desirable or undesirable characteristics of those compositions. Accordingly, there exists a current need in the industry for a novel solution that provides greater access to design composition data in a means that is easy to organize, parse, search, discern, understand, and articulate.

### SUMMARY OF THE INVENTION

The invention is directed to methods and apparatus for associating creative compositions, their composite elements, and their classifying terms with data aggregated from a collection of individual compositions.

Among the many different possibilities contemplated, each embodiment may advantageously comprise data on a collection of comparable creative compositions. That data includes correlations of the characteristics or properties of individual compositions in the collection, including classifications assigned to the composition, the characteristics and properties of the composition as a whole, identification of the constituent elements of the composition, and identification of the properties of the constituent elements of the composition or cognizable representations or replications of the compositions themselves. The data on individual members of the collection is aggregated to identify correlations between compositions, their classifications, their constituent elements, and associations of the properties of all three. These correlations, associations, or statistics may be amended or updated with the inclusion in the collection of data on additional compositions.

The correlations, associations, or statistics derived from the aggregated data may be indexed in association with corresponding compositions, composition properties, composition elements, composition element properties, or composition classifications.

The indexed data may be referenced to easily identify positive or negative correlations between the collection entries and their constituent properties and elements. As may be desirable, the data may also be presented as a system of rankings, ratings, or in a graphical format to enhance human exploitation of the information.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The present invention together with the above and other objectives and advantages may be best understood from the following description of a preferred embodiments of the invention, including the invention illustrations, wherein:

FIG. 1 shows a high level diagram of an exemplary computing system network on which the present invention may be implemented;

FIG. 2 shows a flow chart diagram for an exemplary routine for creating composition entries and updating databases based on data associated with the composition;

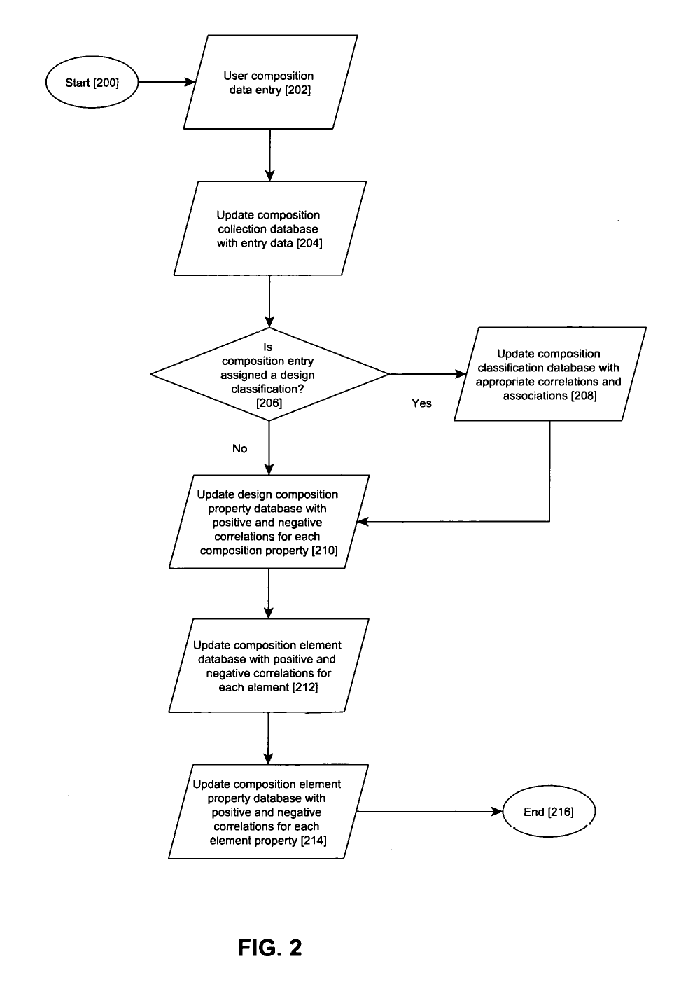

FIG. 3 shows a flow chart diagram for an exemplary routine for updating associations with classifications, composition properties, composition elements, and composition element properties of classifications, compositions, and composition elements based on entry of a composition into the composition collection;

FIG. 4 shows a flow chart diagram for an exemplary user composition search routine in which a user transmits an information request query and the system returns data on appropriate classifications, compositions, composition properties, composition elements, and/or composition element properties or other responsive information in response to the query;

FIG. 5 demonstrates the organization one embodiment of a composition collection database object template;

FIG. 6 demonstrates an example of a composition collection database object;

FIG. 7 demonstrates the organization one embodiment of a composition element database object template; and

FIG. 8 demonstrates an example of a composition element database object.

It should be understood that the associated drawings and descriptions represent but one exemplary embodiment of the present invention. The ordering of the blocks of the illustrated flow charts could be rearranged or moved inside or outside of various routine loops by one skilled in the art. Likewise, various routines or blocks could be broken in to multiple steps for reasons of computational efficiency or ease of maintenance. These illustrations are not intended to limit the scope of the invention.

### DETAILED DISCLOSURE OF THE EXEMPLARY EMBODIMENTS OF THE INVENTION

The present invention relates to methods and computerized systems for exploiting data related to correlations, associations, relationships, or other couplings or connections between creative compositions, their elements, their properties, and their classifications.

The invention provides methods and systems directed to draw objective qualifications of classes of creative compositions based on a collection of compositions. Using a collection of compositions, positive and negative correlations of characteristics may be aggregated and associations may be identified between particular characteristics or elements and classifications of compositions. Using these objective correlations, consumers of creative compositions may supplement or replace vague classification terminology with precise, objective terms or descriptors, techniques, composition elements, or other composition characteristics, thereby facilitating precise and effective communication regarding creative compositions.

The invention also provides a means for individuals otherwise unfamiliar with design principles and terminology of a particular field of composition to commission a composition accurately incorporating their design specifications, without having to master the design field or the field's terminology. These correlations will also help consuming patrons who may not be otherwise versed in the specifics of a given design style to identify and design within the bounds of existing design guidelines and how to employ specific influences in their designs. By identifying specific, objective characteristics of their desired composition, rather than vague design classifications or terms, the patron maximizes the odds that their commissioned work meets their expectations, tastes and criteria.

### I. System Architecture Overview

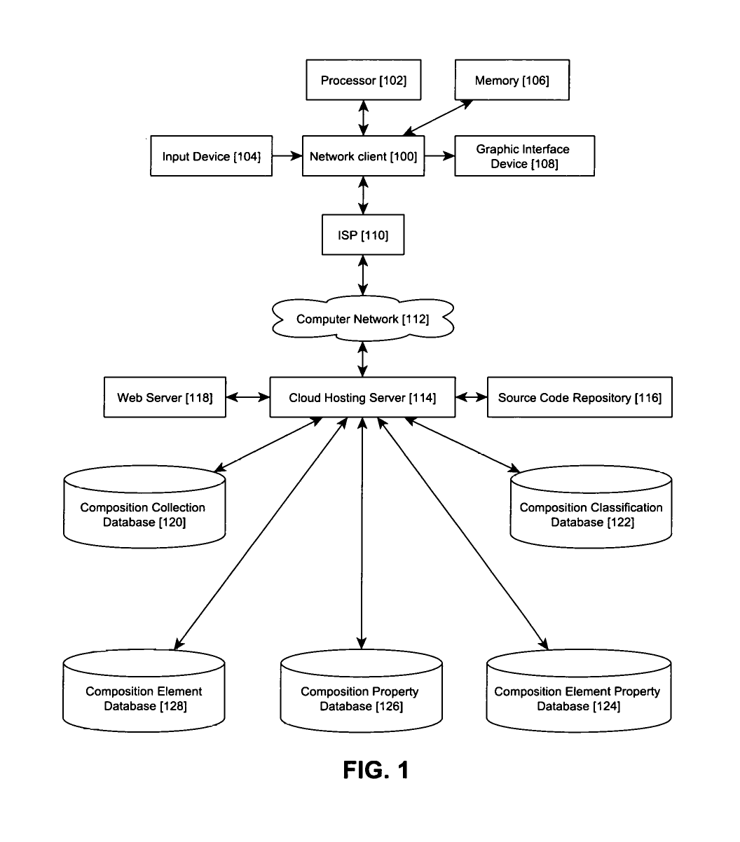

Aspects of the present invention may be implemented on one or more computers executing software instructions. FIG. 1 illustrates an embodiment of the computer system that may be used in one embodiment of the present invention. In the one embodiment, the system of the present invention may be made up of the following components: a network client including a processor, data storage memory, graphical user input display device, alpha-numeric input device, cursor control input device, memory, and/or text output device, a web server computing system, a cloud hosting server, a code source repository, and computer readable data storage medium(s) containing one or more databases.

These components are combined together to create an architecture for the system in which the server computer system transmits and receives data over a computer network or a standard telephone line. The server computer's central processing unit (CPU) executes sequences of instructions to perform the steps of accessing, receiving, storing, transmitting, downloading, or otherwise manipulating the data, as well as other aspects of the present invention. The CPU functions by executing sequences of instructions stored in memory in the code repository. The CPU memory may be in the form of random access memory (RAM), read-only memory (ROM), a persistent store, such as a mass storage device, or any combination of these. Execution of the sequences of instructions causes the CPU to perform steps according to embodiments of the present invention.

The present invention is not limited to any specific combination of circuitry and software, or to any particular source for the instructions executed by the server or client computers. In various embodiments of the system, the instructions may be loaded into the server computer memory from a storage device, from one or more other computer systems over a network connection, from the server computer's own memory storage, or any other source. The instructions may be downloaded and interpreted directly by the server CPU, or may be executed by an interpreter that transforms the instructions into a format readable to the CPU. In some embodiments, part or all of the instructions are embodied in hardwired circuitry in the system.

FIG. 1 illustrates a computer network system that implements one or more embodiments of the present invention. As demonstrated in FIG. 1, a network server computer is coupled, directly or indirectly, to one or more network client computers 100 through a network 110. Network 110 may be the Internet, a Wide Area Network (WAN), a Local Area Network (LAN), intranet, extranet, wireless network, or any combination thereof.

FIG. 1 includes a client computer 100, which, in an exemplary embodiment may be, by way of example and not limitation, a personal computer (PC) system running an operating system. This operating system may be, by way of example and not limitation, Microsoft Windows, Apple Mac/OS, Apple iOS, LINUX, Android, etc. However, the invention may be implemented on any appropriate computer system running any appropriate operating system, such as a computing device, telephone, personal digital assistant (PDA), a smart phone, an iPhone, a handheld PC, proxy servers, network communication servers, etc.

The client computer 100 includes software and hardware for generating a graphical user interface (GUI) and display signals, for rendering on a GUI display 108. The client computer 100 receives input signals, such as queries, instructions, commands, etc., via input device(s) 104, which may be a keyboard, a mouse, a touchpad, a scanner, a touch screen, etc.

The client computer may include input/output (I/O) devices (not shown in FIG. 1) such as, by way of example and not limitation, network interface card, modems, network interface, communications port, transceiver, etc. to allow software and data to be transferred between computer system 100 and external devices.

The computer system 100 may also include one or more processors 102. The computer system 100 may also include, e.g., but may not be limited to, memory storage medium or device 106, such as, by way of example and not limitation, random access memory (RAM), a hard disk drive, removable storage drive, and/or any data storage medium which may be read from and written to by the computer system 100.

The network interface between server computer 118 and client computer 100 may also include one or more routers. The routers serve to buffer and route the data transmitted between the server and client computers.

In one embodiment of the present invention, the server computer 118 is a World-Wide Web (WWW) server that stores data in the form of web pages. The server computer then transmits the stored web pages as Hypertext Markup Language (HTML) files over the Internet network 112 to one or more of the client computers 100. In one embodiment, the client computer(s) 100 interpret and display the web pages served by the server computer 118 via “web browser” programs. Additional web based content can be provided to a client computer by separate content providers, such as a supplemental server 114.

In one embodiment of the present invention, server 118 in the system is a server that executes an information retrieval and transmission process. The information retrieval and transmission process involves the receipt and transmission of data from various client computers, such as network client 100, and processes the received data to process requests received over network 112. The information retrieval and transmission process may represent one or more executable program modules or applications stored within cloud hosting server 114 and executed locally within the server. Alternatively, the information retrieval and transmission process may be implemented in a plurality of different program modules, each of which may be executed by two or more distributed server computers coupled to each other, or to network 112 separately. In a further alternative embodiment, information retrieval and transmission process may be stored on a remote storage or processing device coupled to server or network 112 and accessed by server 118 to be locally executed. It should be noted that a network system 114 that implements embodiments of the present invention may include a larger number of interconnected client and server computers than shown in FIG. 1.

Unless specifically stated otherwise, as apparent from the following discussions, it may be appreciated that throughout the specification discussions utilizing terms such as “processing,” “computing,” “calculating,” “determining,” “manipulating,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

According to an exemplary embodiment, exemplary methods set forth herein may be performed by one or more computer processor(s) adapted to process program logic, which may be embodied on computer accessible storage medium, which when such program logic is executed on the exemplary one or more processor(s) may perform such steps as set forth in the exemplary methods.

### II. User Interfaces

In order for a user to effectively interact with the system, the system may provide a user interface providing GUI objects to facilitate interaction.

In one embodiment of the invention, the system provides three separate user interface GUI formats: an individual user GUI (e.g., for consumers or patrons of compositions), a creator interface (e.g., for creators of compositions), and a system administrator interface (e.g., for those tasked with overseeing the operation of the computer site). Each such interface may enable users, for example, to access the system's database(s) to either query data stored within the database(s), transmit instructions to process and return data stored in the database(s), and/or enter or otherwise manipulate information into the database(s).

It is important to note that alternative embodiments of the invention, particularly those directed toward a particular field of creative composition, may involve additional, different, or other GUIs specialized for different purposes. For example, one embodiment of the invention directed specifically to the field of floral design composition may include GUI interfaces providing, for example, GUI objects for florists, GUI objects for floral designers, GUI objects for bridal industry consultants, GUI objects for consumers seeking to acquire plants to use as gifts, GUI objects for brides, GUI objects for particular occasions, etc. Other embodiments of the invention may not include some of the GUI objects described herein, such as the creator GUI.

Each of the system's interfaces may employ a combination of instructions to display the GUI interface and enable access to various system functionality. Said instructions may be recorded in any computer readable medium such as, by way of example and not limitation, HTML, PHP, CSS, XHTML, Flash, Ajax. It will be understood that the interfaces may be implemented in any computer readable means which enables convenient and efficient human interaction with the system, including applications, executable program files, and the like.

The individual user interface may include, for example and not by way of limitation, GUI objects providing functionality described more fully below, but generally designed to facilitate identification of individual compositions, composition characteristics, composition classifications, composition elements, and composition element characteristics in response to user transmitted database queries. Individual user GUI objects may also enable users to access detailed information on individual compositions, composition properties, composition classifications, composition elements, or composition element properties.

For example, in one embodiment of the system tailored to floral design compositions, the GUI may have individual interface objects directed to accessing data related to the properties of floral compositions stored in the database (e.g., bouquets or arrangements), including a list of the component elements of the composition (e.g., flowers, foliage, accessories, structural materials, etc.), a list of classifications designated for the composition (e.g., rustic, bohemian, natural, 1920s style, etc.), a list of properties of the composition (e.g., size, shape, structure, creation date, creator, patron, etc.), a list of properties of the elements that compose the composition (e.g., shape, color, size, growing season, commercial availability of flowers in the composition, etc.).

In one embodiment of the system, the system may have separate interface objects directed at accessing data related to the properties of elements of floral compositions (e.g., flowers, foliage, accessories, structural support materials, handles, etc.), including, by way of example, for a particular composition element; properties (or property ranges) of the element (e.g., size, shape, color, growing season, etc.); identification of compositions in a collection of compositions which incorporate the element; association or correlation of the element with compositions assigned a particular composition classification (e.g., present in 20% of rustic compositions, 20th most common flower used in rustic compositions, properties size and color included in 30% of rustic compositions, etc.); commercial data on the element (e.g., seasonal availability of a flower in a given region, identification of historical suppliers of the flower in a given season, identification of annual or seasonal price trends for a flower, etc.).

In one embodiment of the system, the system may have separate interface objects directed at accessing data related to the properties of elements of floral compositions (e.g., the properties of flowers, accessories, foliage, etc.), such as, for example, rankings of elements with that property commonly associated with particular design classifications (e.g., the ten flowers with a particular color most commonly included in rustic compositions); the frequency of elements with the property appearing in a particular design classification (e.g., flowers of a particular color appear in 20% of rustic compositions, etc.); the frequency of elements paired with an element which has this property (e.g., the top ten flowers commonly paired with red flowers, etc.); or the frequency of a particular property of elements paired with elements having this property (e.g., the ten colors of flowers most commonly paired with a flower of this color, etc.).

Additionally, the GUI objects may include functionality enabling users to communicate directly with composition creators for the purpose of establishing custom composition requests, inquiring regarding current price, design specifications, and the like.

The composition creator interface may include, for example and not by way of limitation, GUI generally designed to allow suppliers to update information regarding their own compositions or design portfolios, retention details or guidelines, contact details, or other information, some of which may be made available to consumer users of the computer site. In some embodiments, the supplier GUI objects may enable a creator to establish channels of communication through which consumer site users may communicate directly with them regarding custom composition orders or system administrators may communicate with them concerning various aspects of the operation of the computer site.

The system administrator interface may include means for administrators to execute command and control oversight over the computer site's operations. By way of example, and not limitation, this functionality may include interacting with data contained in the site database(s). The administrator GUI may enable administrators to access and analyze data about users in the system, including their current and historical site navigation activity, their user account details, IP information, etc. The administrative interface may also enable administrators to analyze data about the system's information flow and load overall. The administrative interface may display and modify user permissions and access of various users to certain content or functionality at a given time.

### III. Database Organization, Structure, and Maintenance

In one embodiment, the system's database(s) may be updated and maintained by a system administrator via an administrator back end interface dashboard. In one embodiment, the dashboard may include a landing page, from which the administrator may access various administrator functions, including interacting with the user database by entering new or additional compositions, data regarding a composition, including design classifications, composition elements, composition element properties, or composition properties, and populating composition entries and tag categories with individual tags to facilitate user interactions with the database, or generally accessing administrator controls over site settings and communications with users.

The system may provide back end processing to maintain and facilitate interaction with the database(s). The database(s) may be maintained in any computer readable file format, including Standard Query Language (SQL), binary data processed through a Perl DBM Module, or other database formats for query and display in various interface pages. Database information may be stored in the database in a novel bit array or other machine readable encoding format.

Back end processing algorithms may exist as computer code programmed in any suitable language, including, without limitation, Python, HTML, PHP, Ruby, etc. Back end processing may be supported and/or performed by a relational database processing system, such as MySQL, PostgreSQL, SQLite, etc., web server software, such as Apache HTTP Server, Microsoft Internet Information Services (IIS), etc., or system-specific algorithms, routines, or processes. The back end processing components may be incorporated into one or more objects of the user functionality and user GUI objects, including, by way of example and not limitation, the database search routines, computer site page display operations, and/or generation of graphic objects such as tables, graphs, and charts from information stored in the database. The back end processing elements may also, or instead, include other processes to support the system and methods described herein, for example, receiving, sorting, storing, retrieving, processing, and/or otherwise manipulating data used by the system and stored in the database(s), such as individual plant commercial availability and supply data, plant data entries, plant characteristic categories, plant characteristic tags, user account information and details, user saved information on plants or collections of plants, user contact or payment information, and the like. Back end processing may provide algorithms to aggregate, process, and/or calculate data entered, stored, or maintained in the database(s), such as, by way of example and not limitation, aggregating or calculating correlations between design classifications, compositions, composition properties, composition elements, or composition element properties, or transferring, storing, and otherwise facilitating communications between system users.

Via the dashboard, system administrators may create or maintain existing composition or design classification categories.

In one embodiment, possible instantiations of composition or element characteristics are represented as data “tags.” In such an embodiment, administrators may create, maintain, or update such tags from the administrator dashboard. As used herein, “tag” will refer to a data object which can couple database entries which serve as a basis for aggregating and correlating data regarding compositions, composition properties, design classifications, composition elements, or composition element properties, and facilitating queries of database objects and data correlations with content coupled with queried tags. As embodied in the present invention, the dashboard may enable system administrators to assign searchable character strings corresponding to tags. Thus, for example, the tags “red,” “pink,” and “violet” may be assigned to the category “color” for organization in display to users. Via the tag creation GUI, administrators can assign tags names, insert tag references, or select reference names from a dropdown menu.

In one embodiment, the system may maintain and utilize multiple separate databases for various functions. In addition to the database(s), identified in FIG. 1, in one embodiment the system may maintain and update user account databases. Such a database may include content reflecting information provided by the user such as contact information, saved plant collections or plant preferences, as well as information on site activity history.

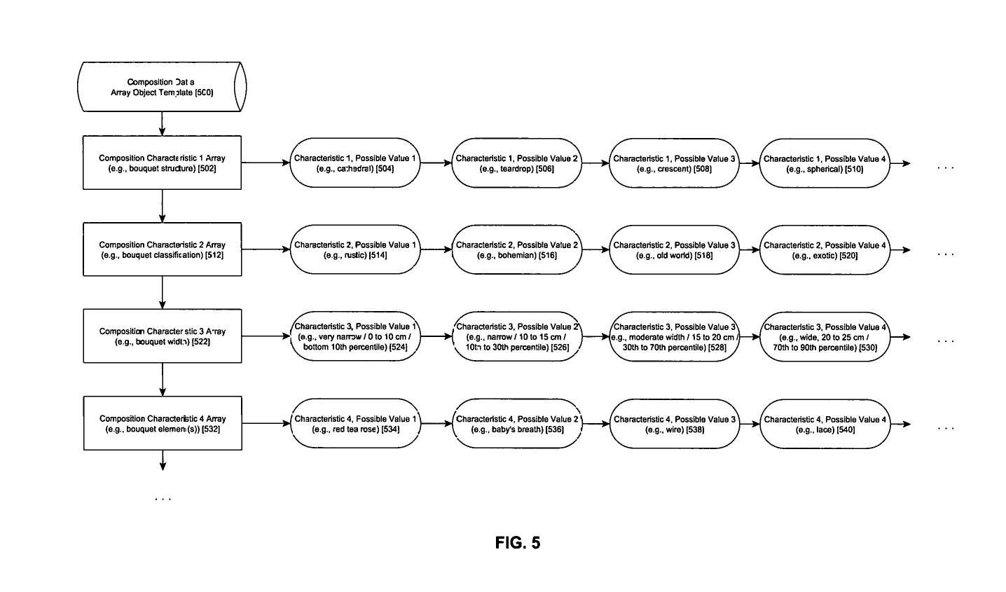

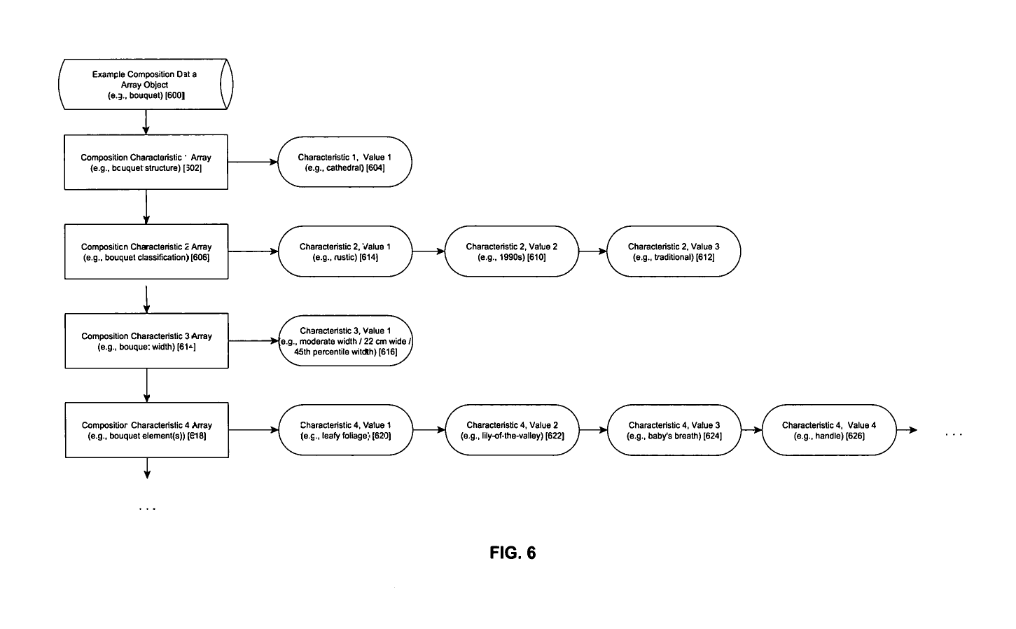

In one embodiment, the system may maintain a database of objects related to creative compositions, which, together, comprise a collection of historical compositions. FIG. 5 is a diagram representing the organizational structure of one exemplary embodiment of such a composition database. FIG. 6 is a diagram representing an example of a database object utilizing this structure.

In one embodiment, the database objects may consist of arrays of data representing information related to the composition represented by the array [502, 512, 522, 532]. For each such array, a template is defined with each data array position representing a separate, internal array listing a category of characteristics [502, 512, 522, 532], and the positions in the internal array representing the particular characteristics possessed by the collection which fall under the collection array position's characteristic category [504, 506, 508, 510, 514, 516, 518, 520, 524, 526, 528, 530, 534, 536, 538, 540].

By way of example, and not limitation, it is helpful to consider an example of such an array structure related to a floral arrangement composition [FIG. 6]. The collection database object is comprised of a composition array containing internal arrays related to the classes of characteristics which may describe the qualities of a floral composition [602, 606, 614, 618]. Thus, the composition array may consist, for example, of an identification array, an image array, a design classification array, a composition element array, a bouquet structure array, a bouquet size array, a bouquet body array, a bouquet element array, etc. and any other arrays for characteristics associated with a bouquet composition, with separate arrays defined for a variety of characteristics of a bouquet [602, 606, 614, 618].

For a particular composition array object, these internal arrays may then be populated with the specific, individual characteristics related to or representative of that bouquet composition [604, 608, 610, 612, 616, 620, 622, 624, 626]. For example, a rustic bouquet may be populated with zero or more names or identification number in the identification array (e.g., a name or identification number for the bouquet composition, etc.), zero or more graphic representations of the composition in the image array (e.g., photographs or drawings of the composition, etc.), zero or more design classifications (e.g., rustic, whimsical, etc.) in the design classification array [606], zero or more structures (e.g., crescent, cathedral, hand-tied, cascade, etc.) in the structure array [604], zero or more widths (e.g., narrow, medium, wide, etc.) in the size array [616], and so forth for as many internal characteristic arrays as may be defined within such a particular embodiment of the invention.

To facilitate the entry of composition objects, one embodiment of the system may rely on a composition template [FIG. 5]. Such a composition template could be defined as a composition array object delineating all characteristic category arrays defined in the embodiment and all values within each internal composition category array as defined within that embodiment of the invention. Each possible internal composition value would be assigned a “tag” within the system to facilitate correlation, association, or grouping of database objects. In such an embodiment of the system, each possible value of attribute would be segregated into a number of potential assignable characteristics for each composition characteristic category. For example, for a composition category related to “width,” the composition category template may be delineated into the assignable values, “vary narrow,” “narrow,” “moderate,” “wide,” and “very wide,” each of which may be understood to refer to a particular range of width in inches or centimeters [522, 524, 526, 528, 530].

Alternatively, a particular composition array element may be configured to accept alpha-numeric values representing a measurement, range, amount, or other value [524, 526, 528, 530]. In such an embodiment, for example, a composition category “width” may be configured to accept values corresponding to any numeric value representing a measurement width, for example, “12 inches,” “16 inches,” or “25 centimeters,” etc. Optionally, descriptive values or tags may be assigned to value ranges, for example, “very narrow” bouquets may consist of bouquets between 0 and 10 centimeters wide; “narrow” bouquets may consist of bouquets between 10 and 15 centimeters wide, moderate bouquets may consist of bouquets between 15 and 20 centimeters wide, etc. Alternatively, descriptive value tags may be assigned relatively based on a bouquet's value in comparison to other bouquets in the collection, for example, “very narrow” bouquets being assigned as bouquets in the lowest 10% of width in the collection, “narrow” bouquets being assigned as bouquets with width between the bottom 10% and 30%; “moderate” width description being assigned to bouquets from the 30% to 70% width relative to the other bouquets in the collection, etc.

In one embodiment, the composition characteristic array may include as one of its elements a separate array listing the composition elements from which the composition is comprised [532, 534, 536, 538, 540]. The composition element array may relate to the individual composition elements comprised in the composition element database [128, 618, 620, 622, 624, 626].

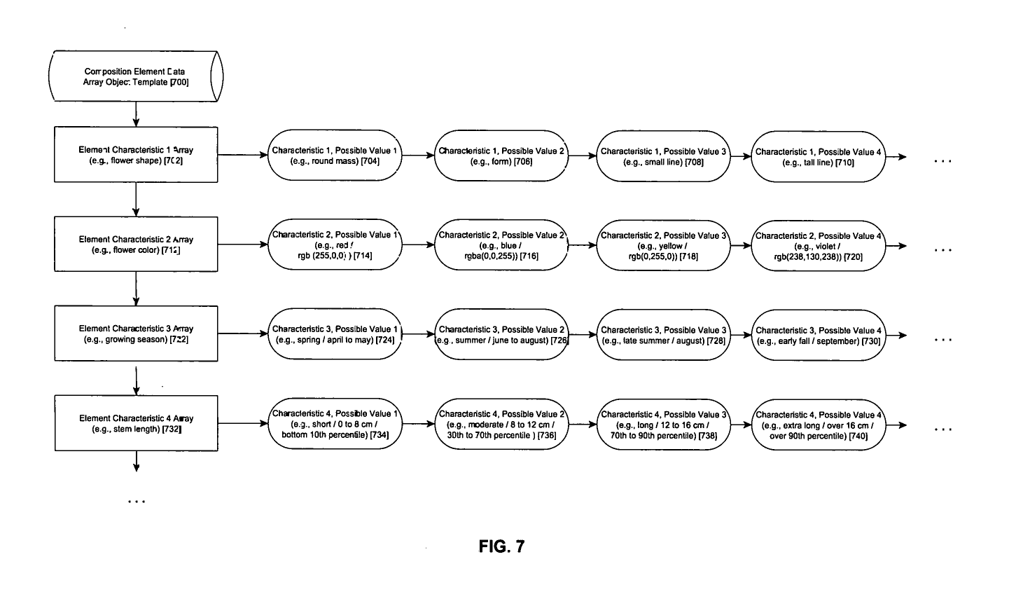

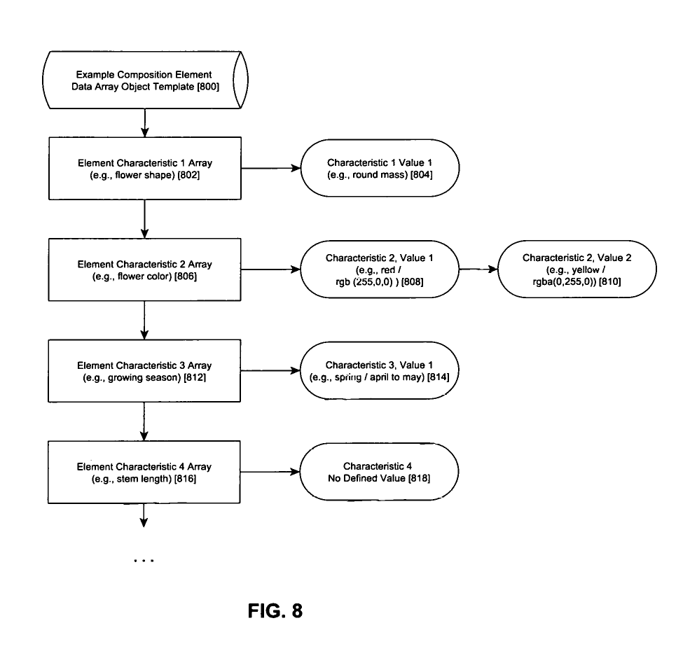

In one embodiment, the system may maintain a database of objects related to composition elements, which, together, comprise a collection of those components, materials, or elements which are or may be used to compose a creative composition. FIG. 7 is a diagram representing the organizational structure of one exemplary embodiment of such a composition element database. FIG. 8 is a diagram representing an example of a composition element database object.

In one embodiment, such a composition element database may be organized similarly to the composition database describe above [FIG. 5, FIG. 6]. Composition element database objects may consist of arrays of information representing data regarding the composition element represented by the array [FIG. 7, 702, 712, 722, 732]. For each such array, a template [FIG. 7] is defined with each data array position representing a separate, internal array listing a category of characteristics [702, 712, 722, 732], and the positions in the internal array representing each of the possible characteristic values possessed by an element which fall under the element array position's characteristic category [704, 706, 708, 710, 714, 716, 718, 720, 724, 726, 728, 730, 734, 736, 738, 740].

By way of example, and not limitation, it is helpful to consider an example of such an array structure related to floral arrangement composition elements [FIG. 8]. The collection database object is comprised of a composition element array containing internal arrays related to the classes of characteristics which may describe the qualities of floral composition elements [802, 806, 814, 818]. Thus, the composition element array may consist, for example, of an identification array, an image array, a design classification array, a composition element array, a bouquet structure array, a bouquet size array, a bouquet body array, a bouquet element array, etc., and any other arrays associated with characteristics of bouquet element characteristics, with separate arrays defined for a variety of characteristics of a bouquet element [802, 806, 814, 818].

For a particular composition element array object, these internal arrays may then be populated with the specific, individual characteristics related to or representative of that bouquet composition [804, 808, 810, 814, 818]. For example, a tea rose may be populated with zero or more names or identification number in the identification array (e.g., a name or identification number for the flower, such as “tea rose,” etc.), zero or more graphic representations of the rose in the image array (e.g., photographs or drawings of the flower, etc.), zero or more flower shape properties (e.g., small mass, etc.) in the flower shape array [802, 804], zero or more colors (e.g., red, yellow etc, etc.) in the color array [806, 808, 810], zero or more growing seasons (e.g., spring, May, April to May, etc.) in the growing season array [812, 814], zero or more stem lengths (e.g., short, long, 0 to 10 cm, 10^{th} to 30^{th} percentile, etc.) in the stem length array, and so forth for as many internal element characteristic arrays as may be defined within such a particular embodiment of the invention.

To facilitate the entry of composition element objects, one embodiment of the system may rely on a composition template [FIG. 7]. Such a composition element template could be defined as a composition element array object delineating all characteristic category arrays defined within the system and all characteristic values within the internal composition category arrays as is defined within that embodiment of the invention. Each defined internal composition value could be assigned a “tag” within the system to facilitate correlation, association, or grouping of database objects. In such an embodiment of the system, each defined characteristic category array would be segregated into a number of potential assignable characteristics for the characteristic category. For example, for a composition element category related to “stem length,” the category template may be delineated into the assignable values, “vary short,” “short,” “moderate length,” “long,” and “very long,” each of which may optionally be understood to refer to a particular range of stem length in inches or centimeters [732, 734, 736, 738, 740].

Alternatively, a particular composition element array may be configured to accept alpha-numeric values representing a measurement, range, amount, or other value [734, 736, 738, 740]. In such an embodiment, for example, a composition category “stem length” may be configured to accept values corresponding to any numeric value representing a measurement width, for example, “8 inches,” “12 inches,” or “16 centimeters,” etc. Optionally, descriptive values or tags may be assigned to value ranges, for example, “very short” stems may consist of flowers with stems between 0 and 10 centimeters long; “short” stems may consist of flowers with stems between 10 and 15 centimeters long, moderate stems may consist of flowers with stems between 15 and 20 centimeters long, etc. Alternatively, descriptive value tags may be assigned relatively based on a bouquet's value in comparison to other bouquets in the collection, for example, “very short” stems being assigned as flowers with stems in the lowest 10% of length in the composition element collection, “short” bouquets being assigned as flowers with stems between the bottom 10% and 30% of stem length; “moderate” stems being assigned to flowers between 30% to 70% stem length relative to the other bouquets in the collection, etc.

In one embodiment, the composition element characteristic array may include a characteristic category comprising names, identification numbers, or other identifying information indicating compositions which comprise the composition element.

In one embodiment, in addition to the composition collection database and the composition element database, the system may comprise a database of composition properties, which identifies a list of descriptive or identifying characteristics of a composition. Such characteristics may relate to the list of defined composition characteristics which comprise the composition collection array object characteristic arrays.

In one embodiment, the system may also comprise a composition element property database. The composition element property database may comprise a collection of composition element properties. Such properties may relate to the list of defined composition element properties which comprise the composition element array object characteristic arrays.

In one embodiment, the system may also comprise a composition classification database. The composition classification database may comprise a collection of data objects related to composition design classifications. For example, and not by way of limitation, considering an exemplary embodiment of the system related to floral compositions, the design classification database may include commonly referenced design classifications such as rustic, whimsical, old world, etc. which relate to the look and feel of a composition. Such design classifications may also comprise classifications related to specific cultural associations, which may relate to a cultural, geographical, or time period, such as 1920s, 1990s, French, Japanese, 1920s French, 1990s New England, etc.

In one embodiment of the system, the composition collection database, composition collection property database, composition classification database, composition element database, and composition element property database may comprise data drawing correlations, associations, ratings, and rankings of database objects within those databases with one or more other database objects in the same or another database within the system. Such correlations or associations may be in the form of a statistical correlation, such as, in one example involving a correlation between a bouquet element and a bouquet classification, a particular bouquet element is present in 25% of all rustic bouquets. The correlation may be in the form of a ranking, such as a particular flower is the 20^{th} most commonly included flower in rustic bouquets.

In one embodiment, such correlations may include derivations based on a second degree association, relating one database object with another database object based on correlations those objects have with one or more other objects. Such as, for example, a flower associated with a design classification based on the properties of the flower. For example, a particular flower may have one or more properties present in 25% of all rustic bouquets. The correlation may also be in the form of a ranking, such as the aggregate characteristics of a particular flower are, on average, present in 20% of all rustic bouquets.

In one embodiment, the correlation data for collection database objects may be comprised as entries in each of the collection database characteristic sub-arrays. Thus, for example, where a bouquet database array object includes a sub-array of data related to bouquet structure, which includes the structure value for that composition of “cathedral” bouquet [602, 604], the bouquet structure sub-array may also contain data correlating “cathedral” bouquet structures generally with other bouquet composition objects, bouquet composition property objects, bouquet classification database objects, bouquet element database objects, or bouquet element property database objects. In the preceding example, such a value might include, for example, a sub-array value relating “cathedral” structure bouquets with particular bouquet element objects in the bouquet element object data array, for example, the “leafy foliage” bouquet element is present in 70% of cathedral bouquets. Such association values may be included for zero, one, many, or all other database objects in each of the system's databases. Similarly, with regard to bouquet element database objects, the object sub-arrays may comprise values relating to correlations between one or more other database objects.

In one embodiment, the system may maintain and update a composition creator database. Such database may contain data referring to information provided by creators regarding current and historical data on composition history, composition elements, composition portfolio, price, availability, contact information, as well as data on communications with individual site users. In one embodiment, the system may allow composition creators to individually create composition entries in the composition collection database, and enter associated information on the entered composition.

It is important to note that alternative embodiments of the invention may organize and maintain one or more databases differently. Some embodiments of the invention may maintain a single database organizing all composition data, including data on design classifications, composition properties, composition elements, or composition element properties.

### V. Data Aggregation and Correlation Routine Overview

In one embodiment, the correlation or aggregation data included in the database(s) consists of a series of correlations between one database object and one or more database objects. In one embodiment, these correlations relate to the prevalence of particular characteristics, elements, or other identifiable qualities together with a particular design classification, composition, composition property, composition element, or composition element property. In one embodiment, these correlations relate to the frequency of appearance of a property, element, or other object in some number of compositions as compared to the total number of compositions, or a sub-set of compositions with a particular characteristic or property.

Accordingly, as one or more database is augmented with additional compositions, the correlation or association data may be updated to reflect the addition of compositions bearing certain combinations of properties, characteristics, elements, or classifications.

By way of example, consider one exemplary embodiment of the system with a collection comprised of 100 bouquet compositions. In such a collection, consider that ten of the objects, or ten percent of the total are assigned a design classification “rustic” and twenty of the collections include the bouquet composition element “tea rose.” Consider that of the bouquet compositions designated “rustic,” five contain the element “tea rose.” In such an embodiment, the system may contain correlation or association information to indicate that “rustic” bouquets maintain a rate of 10% prevalence, tea roses, as a bouquet element, are included at a rate of 20% prevalence, rustic bouquets with tea rose elements comprise 5% of the total collection, 50% of rustic bouquets in the collection contain tea rose elements, and 25% of bouquets with tea roses are designated with the “rustic” design classification.

Further considering the above example, consider the case in which 100 new bouquet compositions are added to the collection. These compositions include twenty “rustic” compositions, five compositions including “tea rose” composition elements, and five compositions that include tea roses and are designated the “rustic” design classification. Following this addition, the system's correlation or association data entries would be updated and the resulting associations would now include a rate of 15% prevalence of “rustic” classified compositions (30 of 200), a 12.5% prevalence of compositions including the “tea rose” element (25 of 200), a 5% prevalence of “rustic” classified compositions which comprise the “tea rose” element (10 of 200), a 33.33% prevalence of “tea rose” elements in bouquets classified as “rustic,” and a 40% rate of bouquets containing “tea rose” to be classified as “rustic.”

In one embodiment of the system, each association or correlation will be updated by employing an algorithm that periodically inspects each composition and its qualities, and recalculates the prevalence of each database object with one or more other database objects in the collection. In one embodiment, this algorithm may be employed each time a database object is updated or a new object is added to a database. In another embodiment of the system, the algorithm may be employed at regular intervals to update the correlation data entries. In another embodiment of the system, the set of associations is updated manually and may be entered into the system by a system administrator.

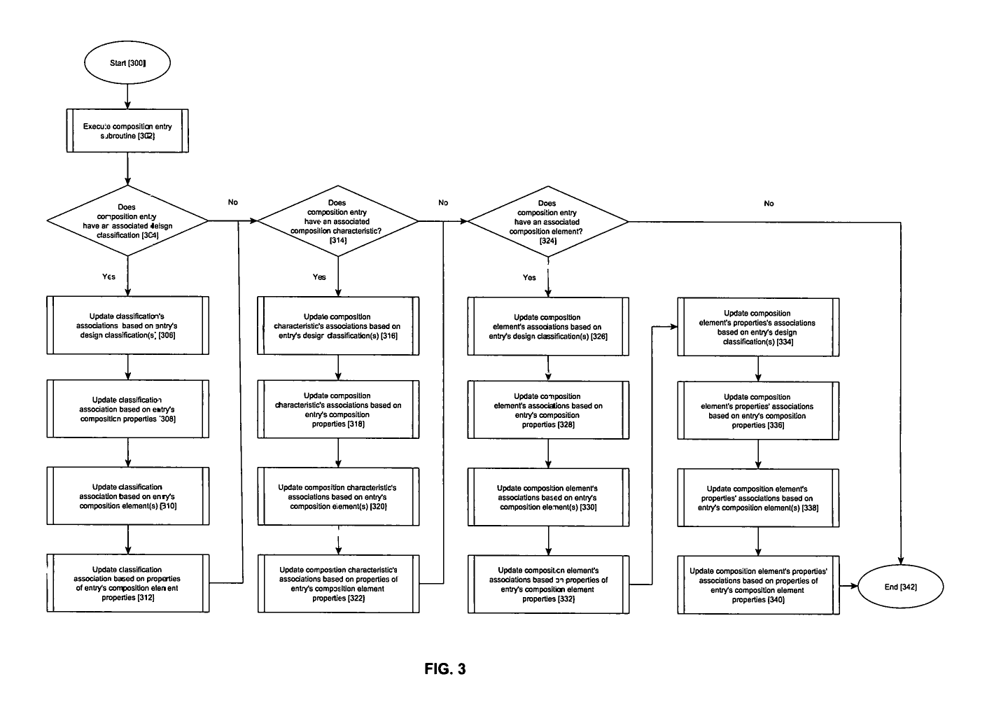

One embodiment of the correlation data updating algorithm is depicted in FIG. 3. On entry of a composition entry, the system checks whether the composition has associated design classification [304], composition characteristic [314], or composition entry [324] data. If the new entry includes design classification data [304], then the system updates the design classification's associations with other design classifications [306], the entry's composition properties [308], the entry's composition elements [310], and the entry's composition element properties [312]. If the entry includes data on one or more composition characteristics [314], then the system updates association data for the composition characteristic in relation to design classifications [316], composition properties [318], composition elements [320], and composition element properties [322]. If the entry includes data on one or more composition elements [324], then the system updates the composition element association data based on its relation with design classification(s) [326], composition properties [328], composition elements [330], composition element properties [332], and the system then updates the element's properties association data based on its relation with design classification(s) [334], composition properties [336], composition elements [338], or other composition element properties [340].

### VI. Composition Information Search, Index, and Identification Routine Overview

In order to facilitate user identification of compositions, composition properties, composition elements, composition element properties, design classifications, composition creators, or correlations or associations between them, the system may enable users to interact with a database, to query and inspect data. In general, the search, indexing, and identification process represents a suite of programs or components that together provide a convenient and efficient means for a user to interact with and identify individual database entry selections that involve various tasks and shared data objects and content. The database entry selection process may include or access a local or remote database that stores a document, a data file, a program, or another object associated with the plant searching and indexing process.

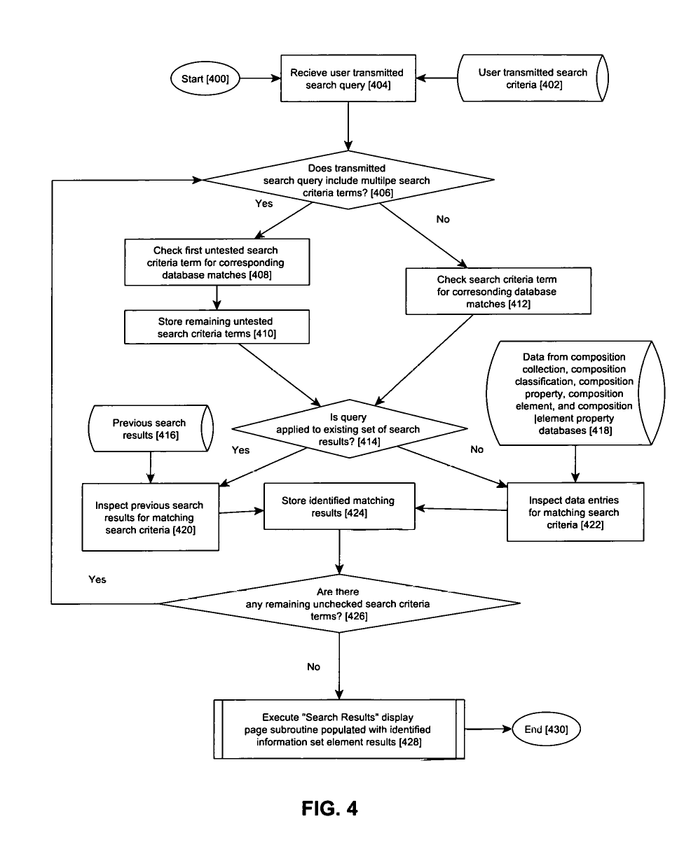

FIG. 4 is a flowchart diagram demonstrating an exemplary embodiment of the computerized method's search routine execution.

The query in the embodiment illustrated in FIG. 4 includes various software processes that coordinate the basic steps of receiving a data query from the user, transmitting the query data to an application server and database for identification of responsive database objects, correlations, or associations, identification of one or more responsive data objects, transmitting one or more responsive objects to the user's point of interface, and displaying a responsive set of identified plant data 420, 422. The system initiates the search routine upon receipt of a query [402, 404]. Upon receipt of a query, the system compares elements of a database to identify data tags corresponding to the query and returns corresponding objects from the database [420, 424]. The system then returns instructions for the user interface device to display the returned results, with the user option to refine those search results by entering additional queries [428].

In one embodiment, in response to multiple character strings separated by one or more spaces in a text search field, the system compares each string to database objects and returns database objects corresponding to each of the [406, 408, 410, 414, 416, 420, 424, 426]. As one of multiple character strings is inspected, and corresponding results are returned [408], remaining unchecked criteria are temporarily stored while each sequential database entry match inspection is preferably performed [410]. For the first character string tested, the system identifies corresponding results from the database [424]. Then, if there are remaining, unchecked criteria stored in memory, the system performs additional match inspection routines limited to the results already returned by previous sequential searches [406, 426]. Once all user transmitted character strings have been inspected, the system returns and displays a list of results from the database which include tags matching all of the user transmitted character strings [428]. In the search display interface, a list of all search tags appears above the search results, informing the user of the scope of the performed search.

In one embodiment, a user may refine a list of returned search results by submitting a query applied to the results of a prior search rather than an entire field of database objects. When a user transmits a query from an existing search results page (rather than from the general search page), the system may check the query against the set of results displayed on the page rather than searching the entire plant information database for all matching results [414, 420, 424]. In this way, a user may refine existing search results to identify plants with multiple characteristic criteria.

### VII. Individual Database Object Information Page Display and GUI Functionality

In one embodiment, the system GUI facilitates access to data associated with a particular database object. In one embodiment, the individual database object information page display routine sequentially checks a list of defined data categories pertaining to database object properties, elements, associations, or correlations and displays fields for which tags are assigned to a database object entry.

It will be appreciated that in alternative embodiments of the invention, the information presented on a database object information page may be presented in various configurations, not limited to the organization presented in the accompanying drawings, or in multiple pages organized differently than the organization described herein, as is preferable to optimize and enhance user experience.

### VIII. Alternative Embodiments

It will be understood that various modifications can be made to the embodiments of the present invention herein disclosed without departing from the spirit and scope thereof. The invention may be directed toward one or more computer systems capable of carrying out the functionality described herein, and may find applicability in any computing or processing environment with any type of machine that is capable of running machine-readable instructions. For example, the principles of the invention may apply to other computer applications, such as other mainframes, minicomputers, network servers, personal computers, handheld mobile units or computing devices, as well as other electronics applications. Also, various modifications may be made in the configuration of the parts and the steps of the process. Therefore, while the discussion herein focuses on a particular application, it should be understood that the invention is not limited to the particular hardware designs, software designs, communications protocols, performance parameters, or application-specific functions disclosed herein.

A person skilled in the art will appreciate that the method and system of the present invention may be utilized in environments other than the Internet. The invention may be implemented using computer programming or engineering techniques including computer software, firmware, hardware or any combination or subset thereof. Any such resulting program, having computer-readable code means, may be embodied or provided within one or more computer readable media, thereby making a computer program product, i.e., an article of manufacture, according to the invention. The computer readable media may be any data storage device that can store data, which thereafter can be read by a computer system, such as, for example, a fixed (hard) drive, diskette, optical disc, magnetic tape, semiconductor memory such as read-only memory (ROM), etc., or any transmitting/receiving medium such as the Internet or other communications network or link.

Likewise, while the embodiments described herein are described in terms of interface programs that utilize web server and web browser programs, these document production processes may be implemented as proprietary or dedicated software programs that communicate over public or private computer networks coupling the on-line project management system to users.

The computer readable storage medium containing the computer code may be made, used, and/or distributed by executing the code directly from one medium, by copying the code from one medium to another medium, or by transmitting code over a network. An apparatus for making, using or selling the invention may be one or more processing systems including, but not limited to, a central processing unit (CPU), memory, storage devices, communication links and devices, servers, I/O systems, including software, firmware, hardware or any combination or subset thereof, which embody the invention as set forth in the claims. User input may be received from the keyboard, mouse, pen, voice, touch screen, or any other means by which a human can input data to a computer, including through other programs such as application programs.

All or part of the system can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Specifically, it will be appreciated that one or more of the methods employed in the above described embodiment of the invention may be realized as computer executable code created using a structured programming language, object oriented programming language, markup language, or any other high-level or low-level programming language that may be stored, compiled or interpreted to run on a data processing apparatus, as described above, as well as heterogeneous combinations of processors, processor architectures, or combinations of different hardware and software, including, without limitation, C, C++, Visual Basic, HTML, XHTML, Java, VBScript, Jscript, BCMAscript, Javascript, DHTM1, XML, CGI, ASP, assembly language, hardware description languages, or database programming languages and technologies, including, without limitation, MySQL, Microsoft SQL Server, IBM AS 400 or the like.

All or part of the computer system can be implemented in a computing system that includes a back-end component, e.g., as a data server, or that includes a middleware component, e.g., and application server, or that includes a front-end component, e.g., a client computer having a graphical user interface or a web browser through which a user can interact with an implementation of the plant search and indexing system, or any combination of such back-end, middleware, or front-end components. The components of the system can be interconnected by any form or medium of digital data communication, e.g., a communication network. Examples of communication networks include a LAN and a WAN, e.g., the Internet.

Method steps associated with the system can be rearranged and/or one or more such steps can be omitted to achieve the same, or similar, results to those describe herein. Individuals skilled in the art will easily be able to combine the software created as described with appropriate general purpose or special purpose computer hardware to create a computer system or computer sub-system embodying the method of the invention. Individuals skilled in the art will also envision other modifications within the scope and sprit of the present invention as defined by the drawings and descriptions set forth herein.

Therefore, it should be understood that the breadth and scope of the described invention should not be limited by any of the above-described exemplary embodiments. The examples and embodiments described herein are for illustrative purposes only and that various modifications or changes in light thereof will be suggested to persons skilled in the art and are to be included within the spirit and purview of this application and the scope of the described invention. The breadth and scope of the described exemplary embodiments should be defined only in accordance with the claims of any patent application(s) claiming the priority and benefit of this provisional application, which claims are incorporated herein by reference.

What is claimed is:

1. A method of referencing, exploiting, correlating, associating, compiling, or organizing data on a design composition, comprising: a plurality of design compositions; and an aggregation or correlation of data related to one or more members of the plurality.

2. The method of claim 1, comprising: an index of data correlating or associating one or more members of the plurality to a design or style classification.

3. The method of claim 2, comprising: an index of data on a design or style classification, which index references aggregated data on an association or correlation between a design or style classification and one or more members of the plurality of design compositions.

4. The method of claim 3, comprising: an index of data on a design or style classification, which index references aggregated data on an association or correlation between the design or style classification and data associated or correlated to one or more members of the plurality of design compositions.

5. The method of claim 1, comprising: an index of data correlating or associating one or more members of the plurality to a design element.

6. The method of claim 5, comprising: an index of data on a design element, which index references aggregated data on an association or correlation between the design element and one or more members of the plurality of design compositions.

7. The method of claim 6, comprising: an index of data on a design element, which index references aggregated data on an association or correlation between the design element and data associated or correlated to one or more members of the plurality of design compositions.

8. The method of claim 1, comprising: an index of data correlating or associating one or more members of the plurality to a property of a design element.

9. The method of claim 8, comprising: an index of data on a property of a design element, which index references aggregated data on an association or correlation between the property and one or more members of the plurality of design compositions.

10. The method of claim 9, comprising: an index of data on a property of a design element, which index references aggregated data on an association or correlation between the property and data associated or correlated to one or more members of the plurality of design compositions.

11. The method of claim 1, comprising: an index of data correlating or associating one or more members of the plurality to a property of a design composition.

12. The method of claim 11, comprising: an index of data on a property of a design composition, which index references aggregated data on an association or correlation between the property and one or more members of the plurality of design compositions.

13. The method of claim 12, comprising: an index of data on a property of a design composition, which index references aggregated data on an association or correlation between the property and data associated or correlated to one or more members of the plurality of design compositions.

14. The method of claim 1, comprising: an index of data correlating or associating one or more members of the plurality to a design composition.

15. The method of claim 14, comprising: an index of data on a design composition, which index references aggregated data on an association or correlation between the composition and one or more members of the plurality of design compositions.

16. The method of claim 15, comprising: an index of data on a design composition, which index references aggregated data on an association or correlation between the composition and data associated or correlated to one or more members of the plurality of design compositions.

17. The method of claim 1, comprising: an index of data related to the plurality of compositions, which index comprises correlations between one or more of the following: a design classification; a design composition; a property of a design composition; a design element; or a property of a design element.

18. A computerized system comprising: a network interface unit configured to communicate with a network; a plurality of processors, each with an associated memory, in communication with the network interface unit; a first database of information correlated to a plurality of design compositions; and capable of returning data in response to user input.

19. The system of claim 18, comprising: a second database; which second database comprises data on one or more design elements; which data comprises a correlation or association between the design element and one or more members of the plurality of compositions.

20. The system of claim 19, wherein: the second database comprises data correlating the design element to one or more of the following: a design classification; a design composition; a property of a design composition; a design element; or a property of a design element.

21. The system of claim 20, comprising: an algorithm by which the data in the second database is adjusted upon the inclusion of a second design composition to the plurality of compositions; wherein the adjustment reflects correlation or association of the design element with one or more properties of the second design composition.

22. The system of claim 21, comprising: an algorithm by which a user may submit a query regarding a correlation or association of the design element with one or more of the following: a design classification; a design composition; a property of a design composition; a design element; or a property of a design element; wherein the system returns data in human readable format on the queried correlation or association in response to the query.

23. The system of claim 18, comprising: a third database; which third database comprises data on one or more properties of a design element; which data comprises a correlation or association between the property and one or more members of the plurality of compositions.

24. The system of claim 23, wherein: the third database comprises data correlating the property to one or more of the following: a design classification; a design composition; a property of a design composition; a design element; or a property of a design element.

25. The system of claim 24, comprising: an algorithm by which the data in the third database is adjusted upon the inclusion of a second design composition to the plurality of compositions; wherein the adjustment reflects correlation or association of the element property with one or more properties of the second design composition.

26. The system of claim 25, comprising: an algorithm by which a user may submit a query regarding a correlation or association of the design element with one or more of the following: a design classification; a design composition; a property of a design composition; a design element; or a property of a design element; wherein the system returns data in human readable format on the queried correlation or association in response to the query.

27. The system of claim 18, comprising: a fourth database; which fourth database comprises data on one or more design or style classifications; which data comprises a correlation or association between the classification and one or more members of the plurality of compositions.

28. The system of claim 27, wherein: the fourth database comprises data correlating the classification to one or more of the following: a design classification; a design composition; a property of a design composition; a design element; or a property of a design element.

29. The system of claim 28, comprising: an algorithm by which the data in the fourth database is adjusted upon the inclusion of a second design composition to the plurality of compositions; wherein the adjustment reflects correlation or association of the correlation with one or more properties of the second design composition.

30. The system of claim 29, comprising: an algorithm by which a user may submit a query regarding a correlation or association of the classification with one or more of the following: a design classification; a design composition; a property of a design composition; a design element; or a property of a design element; wherein the system returns data in human readable format on the queried correlation or association in response to the query.

31. The system of claim 18, comprising: a fifth database; which fifth database comprises data on one or more composition properties; which data comprises a correlation or association between the composition property and one or more members of the plurality of compositions.

32. The system of claim 31, wherein: the fifth database comprises data correlating the composition property to one or more of the following: a design classification; a design composition; a property of a design composition; a design element; or a property of a design element.

33. The system of claim 32, comprising: an algorithm by which the data in the fifth database is adjusted upon the inclusion of a second design composition to the plurality of compositions; wherein the adjustment reflects correlation or association of the composition property with one or more properties of the second design composition.

34. The system of claim 33, comprising: an algorithm by which a user may submit a query regarding a correlation or association of the composition property with one or more of the following: a design classification; a design composition; a property of a design composition; a design element; or a property of a design element; wherein the system returns data in human readable format on the queried correlation or association in response to the query.

35. The system of claim 18, comprising: a sixth database; which sixth database comprises data on one or more design compositions; which data comprises a correlation or association between the design compositions and one or more members of the plurality of compositions.

36. The system of claim 35, wherein: the sixth database comprises data correlating the design compositions to one or more of the following: a design classification; a design composition; a property of a design composition; a design element; or a property of a design element.

37. The system of claim 36, comprising: an algorithm by which the data in the sixth database is adjusted upon the inclusion of a second design composition to the plurality of compositions; wherein the adjustment reflects correlation or association of the design composition with one or more properties of the second design composition.

38. The system of claim 37, comprising: an algorithm by which a user may submit a query regarding a correlation or association of the design composition with one or more of the following: a design classification; a design composition; a property of a design composition; a design element; or a property of a design element; wherein the system returns data in human readable format on the queried correlation or association in response to the query.

39. The system of claim 19, wherein: the second database is the first database.

40. The system of claim 23, wherein: the third database is the first database.

41. The system of claim 27, wherein: the fourth database is the first database.

42. The system of claim 31, wherein: the fifth database is the first database.

43. The system of claim 35, wherein: the sixth database is the first database.

44. The system of claim 18, wherein: the system returns data on a correlation or association in a human readable, graphic format.

45. The system of claim 18, wherein: the first database comprises a visual representation of one or more of the plurality of compositions.

46. The system of claim 19, wherein: the second database comprises a visual representation of one or more design elements.

47. The system of claim 23, wherein: the third database comprises a visual representation of one or more design element properties.

48. The system of claim 27, wherein: the fourth database comprises a visual representation of one or more classifications.

49. The system of claim 31, wherein: the fifth database comprises a visual representation of one or more composition properties.

50. The system of claim 35, wherein: the sixth database comprises a visual representation of one or more compositions.

51. The system of claim 23, wherein: the third database comprises data on a design element associated or correlated with one or more design element properties.

52. The system of claim 49, wherein: the fifth database comprises data on a design composition associated or correlated with one or more design element properties.
